(19) United States
(12) Patent Application Publication
(10) Pub. No.: US 2015/0214750 A1
(43) Pub. Date: Jul. 30, 2015

(54) WIRELESS POWER SYSTEM

(71) Applicant: POWERMAT TECHNOLOGIES LTD., NEVE ILAN (IL)

(72) Inventors: Oz MOSHKOVICH, Rehovot (IL); Arik ROFE, Jerusalem (IL); Elieser MACH, Rosh Tzurim (IL); Yuval KOREN, Rehovot (IL); Guy RAVEH, Mataa (IL); Rotem SHRAGA, Beer Sheva (IL); Arye NUDELMAN, Jerusalem (IL); Rinat BURDO, Jerusalem (IL)

(21) Appl. No.: 14/607,808

(22) Filed: Jan. 28, 2015

Related U.S. Application Data
(60) Provisional application No. 61/932,259, filed on Jan. 28, 2014.

(51) Int. Cl. H02J 5/00; H02J 7/02

(52) U.S. Cl. CPC H02J 5/005; H02J 7/025

(57) ABSTRACT

A wireless power system comprising a secondary unit and a wireless power outlet configured to provide an electric charge wirelessly to the secondary unit comprises a primary inductive coil connected to a power source via a driver configured to provide an oscillating driving voltage to the primary inductive coil. The secondary unit is configured to receive an electric charge wirelessly from the wireless power outlet, and comprises a secondary inductive coil wired to an electric load. The wireless power outlet and secondary unit are each configured to ensure compatibility with one another.

### CROSS-REFERENCE TO RELATED APPLICATIONS

This application claims the benefit of U.S. provisional application Ser. No. 61/932,259 filed Jan. 28, 2014, the disclosure of which is hereby incorporated in its entirety by reference herein.

### TECHNICAL FIELD

The present disclosure relates to wireless power outlets, and to methods of transferring power thereby.

### BACKGROUND

Inductive power coupling allows energy to be transferred from a power supply to an electric load without a wired connection there between. An oscillating electric potential is applied across a primary inductor. This sets up an oscillating magnetic field in the vicinity of the primary inductor. The oscillating magnetic field may induce a secondary oscillating electrical potential in a secondary inductor placed close to the primary inductor. In this way, electrical energy may be transmitted from the primary inductor to the secondary inductor by electromagnetic induction without a conductive connection between the inductors.

When electrical energy is transferred from a primary inductor to a secondary inductor, the inductors are said to be inductively coupled. An electric load wired in series with such a secondary inductor may draw energy from the power source wired to the primary inductor when the secondary inductor is inductively coupled thereto.

In order to take advantage of the convenience offered by inductive power coupling, inductive outlets having primary inductors may be installed in different locations that people typically use to rest their devices, such that they may be charged while at rest.

There are several standards for transferring power inductively. Not all standards are designed to be compatible with one another, and attempting to transfer power to a secondary unit according to a standard for which it is not designed may cause damage thereto. This is a particular concern if the standard according to which the attempt is made uses more power than the standard according to which the secondary unit is designed.

### SUMMARY

According to one aspect of the presently disclosed subject matter, there is provided a wireless power outlet configured to provide an electric charge wirelessly to a secondary unit, the wireless power outlet comprising a primary inductive coil connected to a power source via a driver configured to provide an oscillating driving voltage to the primary inductive coil, the wireless power outlet being characterized by one or more selected from the group consisting of:
peak voltage across the primary inductive coil changes by at least 3V when a secondary inductive coil of the secondary unit is within a predetermined distance thereof;
a transition time between “Standby” and “Power Transfer” operational phases thereof does not exceed one second;
a response to a change request from the secondary unit is responded to by the wireless power outlet within 150 ms; and
receipt thereby of an invalid signal results in termination of power transfer.

According to another aspect of the presently disclosed subject matter, there is provided a secondary unit configured to receive an electric charge wirelessly from a wireless power outlet, the unit comprising a secondary inductive coil wired to an electric load and being characterized by one or more selected from the group consisting of:
placement thereof on a surface of the wireless power outlet induces a difference of at least −40 Gauss in a DC magnetic field thereof;
an output of the secondary inductive coil remains closed until a signal, identifying itself as compliant with the wireless power outlet, is transmitted and a predetermined period of time elapses;
receipt of a digital ping from the wireless power outlet induces a response having a frequency of at least 7.6 kHz and no greater than 8.4 kHz;
an “Identification” operation phase thereof comprises transmitting, within 180 ms, signals indicating one or more of requesting increased power, requesting decreased power, and requesting no change in power until a stabilized operational point is reached, followed by a signal identifying itself as compliant with the wireless power outlet;
a request is transmitted by the secondary unit when it determines that a power level transmitted by the wireless power outlet should be changed;
a charging state is maintained until the earlier of the electric load reaches full power and the charging state has been maintained for two hours;
no audible sounds are emitted by the secondary unit during normal operation thereof which exceed a sound pressure level of 30 at a distance of one meter;
when charging of the electric load is complete, the secondary unit closes an output of the secondary inductive coil thereof and transmits a signal indicating end of charge;
a signal indicating end of charge is transmitted by the secondary unit when a predetermined error condition is detected;
the secondary unit is configured to transmit a signal identifying itself as compliant with the wireless power outlet upon receiving a digital ping therefrom 25 ms after transfer thereto of electric power terminates; and
no more than 8.5 W are drawn by the secondary unit from the wireless power outlet.

According to a further aspect of the presently disclosed subject matter, there is provided a wireless power outlet configured to provide an electric charge wirelessly to a secondary unit, the wireless power outlet comprising a primary inductive coil connected to a power source via a driver configured to provide an oscillating driving voltage to the primary inductive coil, the wireless power outlet being characterized by one or more embodiments disclosed herein.

According to a still further aspect of the presently disclose subject matter, there is provided a secondary unit configured to receive an electric charge wirelessly from a wireless power outlet, the unit comprising a secondary inductive coil wired to an electric load and being characterized by one or more embodiments disclosed herein.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1 is a schematic illustration of a wireless power system according to embodiments of the presently disclosed subject matter.

### DETAILED DESCRIPTION

As required, detailed embodiments are disclosed herein; however, it is to be understood that the disclosed embodiments are merely exemplary and may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the embodiments and teachings of the disclosure.

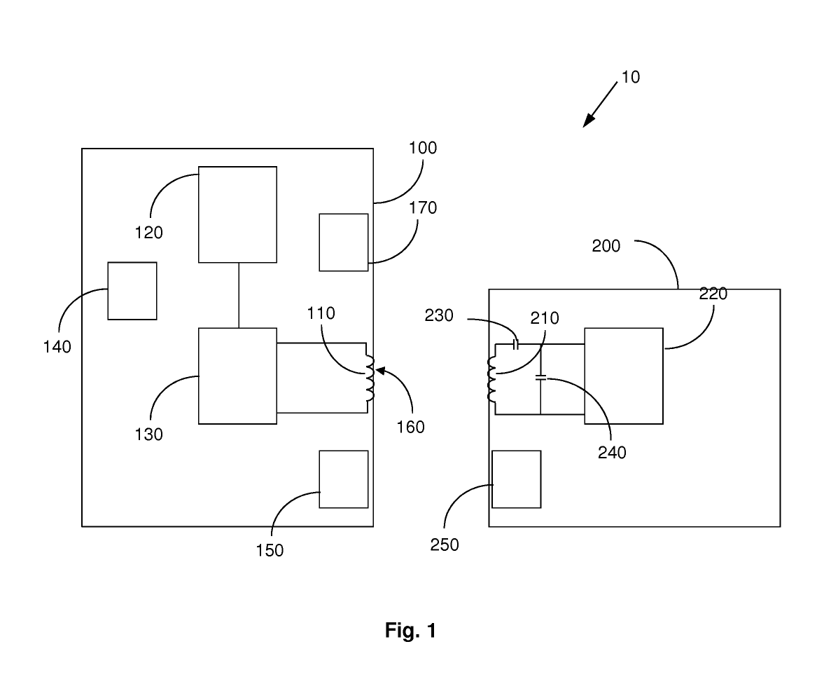

As illustrated in FIG. 1, there is provided a wireless power system, which is generally indicated at 10, comprising a wireless power outlet 100 and a secondary unit 200, which are configured to operate together, inter alia, to transfer power wirelessly from the wireless power outlet to the secondary unit.

The wireless power outlet 100, such as an inductive power outlet, a resonant power outlet, or the like, is configured to transmit power wirelessly to a secondary unit 200 remote therefrom. The wireless power outlet 100 comprises a primary inductive coil 110 connected to a power source 120 via a driver 130. The driver 130 is configured to provide an oscillating driving voltage to the primary inductive coil 110. The wireless power outlet 100 may further comprise a controller 140, such as a microcontroller unit, to direct operation thereof.

The secondary unit 200 comprises a secondary inductive coil 210, wired to an electric load 220, and is configured to form an inductive couple with the primary inductive coil 110. Formation of such an inductive couple facilitates the electric load 220 to draw power from the power source 120. In addition, the secondary unit 200 may comprise one or both of a series capacitor 230 connected serially between the secondary inductive coil 210 and the electric load, and a parallel capacitor 240 connected in parallel to the secondary inductive coil between it and the electric load. The capacitors 230, 240 may contribute to an impedance of the secondary unit 200.

In addition to the transfer of power, the inductive couple may be used to establish a communication channel between a transmitter 250 associated with the secondary unit 200, and a receiver 150 associated with the wireless power outlet 100. The communication channel may provide feedback signals and/or other relevant information to the driver 130.

The wireless power outlet 100 and secondary unit 200 are each configured to meet predefined specifications in order to ensure compatibility with one another. These specifications may relate, inter alia, to electrical, magnetic, and/or physical properties thereof. Some of these specifications are detailed in “PMA Receiver Test Procedures—System Release 1”, by Power Matters Alliance, Inc. (hereafter referred to as “the test procedures”), the full contents of which are incorporated herein by reference.

As used herein, the term “under an alignment condition” or similar language refers to a mutual disposition between the wireless power outlet 100 and the secondary unit 200 wherein centers of the primary inductive coil 110 and secondary inductive coil 210 are fully aligned with one another. In addition, as used herein, the term “under a misalignment condition” or similar language refers to a relative or mutual disposition, misalignment, or displacement between the wireless power outlet 100 and the secondary unit 200 wherein centers of the primary inductive coil 110 and secondary inductive coil 210 are at a maximal distance permitted according to the design of the wireless power outlet, for example according to an industry standard defining its properties and/or characteristics.

According to some embodiments, the system is configured such that placement of the secondary unit 200 on the surface 160 of the wireless power outlet 100 induces a minimal difference, for example at least −40 Gauss, in the DC magnetic field, as detected by the Hall effect sensor 170 of the wireless power outlet. According to some examples, this is accomplished by providing suitable (and suitably-located) materials in the secondary unit 200.

For example, the difference of the output voltage of the Hall effect sensor 170 when the secondary unit 200 is placed on the surface 160 (V_{Delta}_{_{—}}_{Hall}) may depend on the output voltage when the secondary unit is absent therefrom (V_{Hall}_{_{—}}_{W/O}_{_{—}}_{IUT}), under alignment and misalignment conditions, as follows:
for V_{Hall}_{_{—}}_{W/O}_{_{—}}_{IUT}≧1.88V, V_{Delta}_{_{—}}_{Hall} is 165 mV;
for V_{Hall}_{_{—}}_{W/O}_{_{—}}_{IUT}=1.87V, V_{Delta}_{_{—}}_{Hall} is 170 mV;
for V_{Hall}_{_{—}}_{W/O}_{_{—}}_{IUT}=1.86V, V_{Delta}_{_{—}}_{Hall} is 175 mV;
for V_{Hall}_{_{—}}_{W/O}_{_{—}}_{IUT}=1.85V, V_{Delta}_{_{—}}_{Hall} is 180 mV;
for V_{Hall}_{_{—}}_{W/O}_{_{—}}_{IUT}=1.84V, V_{Delta}_{_{—}}_{Hall} is 185 mV;
for V_{Hall}_{_{—}}_{W/O}_{_{—}}_{IUT}=1.83V, V_{Delta}_{_{—}}_{Hall} is 190 mV;
for V_{Hall}_{_{—}}_{W/O}_{_{—}}_{IUT}=1.82V, V_{Delta}_{_{—}}_{Hall} is 195 mV; and
for V_{Hall}_{_{—}}_{W/O}_{_{—}}_{IUT}≦1.81V, V_{Delta}_{_{—}}_{Hall} is 200 mV.

Further details regarding this embodiment can be found in section 3.1.1 of the test procedures.

According to some embodiments, the secondary unit is configured to create a minimum field strength difference of ±20 Gauss between an alignment condition and 8 mm beyond a misalignment condition. This may be measured, e.g., using the Hall effect sensor 170.

Further details regarding this embodiment can be found in section 3.1.2 of the test procedures.

According to some embodiments, the wireless power outlet 100 is configured such that placement of the secondary unit 200 on the surface 160 thereof induces a sufficient voltage difference on the primary inductive coil 110 when an active detection method is used thereby. Accordingly, the peak DC voltage at the primary inductive coil 110 under both alignment and misalignment conditions should differ from the peak DC voltage when no secondary unit is present on the surface by at least 3V. That is:

V_{Delta}_{_{—}}_{DCpeak}_{_{—}}_{W/O}_{_{—}}_{IUT}−V_{DCpeak}_{_{—}}_{W}_{_{—}}_{IUT}_{_{—}}_{aligned}≧3V (1)

V_{Delta}_{_{—}}_{DCpeak}_{_{—}}_{W/O}_{_{—}}_{IUT}−V_{DCpeak}_{_{—}}_{W}_{_{—}}_{IUT}_{_{—}}_{misaligned}≧3V (2)

where V_{Delta}_{_{—}}_{DCpeak}_{_{—}}_{W/O}_{_{—}}_{IUT} is the peak voltage across the primary inductive coil 110 when no secondary unit 200 is on the surface 160, V_{DCpeak}_{_{—}}_{W}_{_{—}}_{IUT}_{_{—}}_{aligned} is the peak voltage across the primary inductive coil under an alignment condition, and V_{DCpeak}_{_{—}}_{W}_{_{—}}_{IUT}_{_{—}}_{misaligned} is the peak voltage across the primary inductive coil under a misalignment condition.

Further details regarding this embodiment can be found in section 3.1.3 of the test procedures.

According to some embodiments, the wireless power outlet 100 is configured such that a maximal transition time between a “Standby” phase a “Power Transfer” phase thereof does not exceed one second. In addition, the secondary unit 200 is configured such that it does not open an output of its secondary inductive coil 210 until an “RXID” signal, which identifies itself to the wireless power outlet 100 as a compliant device therewith, was transmitted and a predetermined guard time, which may be equal to the amount of time necessary for the secondary unit to transmit ten consecutive “PMA NoCh” (i.e., a request to not change the power) signals.

Further details regarding this embodiment can be found in section 3.2.1 of the test procedures.

According to some embodiments, the secondary unit 200 is configured to respond to a digital ping from the wireless power outlet 100 by transmitting a “PMA Dec” (i.e., a request to decrement power) signal which is between 7.6 kHz and 8.4 kHz, inclusive, under both alignment and misalignment conditions. That is:

7.6 kHz≦F_{DigitalPing}_{_{—}}_{PMAsig}_{_{—}}_{aligned}≦8.4 kHz (3)

7.6 kHz≦F_{DigitalPing}_{_{—}}_{PMAsig}_{_{—}}_{misaligned}≦8.4 kHz (4)

where F_{DigitalPing}_{_{—}}_{PMAsig}_{_{—}}_{aligned} is the frequency of the signal received by the wireless power outlet 100 from the secondary unit 200 in response to a digital ping under an alignment condition, and F_{DigitalPing}_{_{—}}_{PMAsig}_{_{—}}_{misaligned} is the frequency of the signal received by the wireless power outlet 100 from the secondary unit 200 in response to a digital ping under a misalignment condition.

According to some examples, the secondary unit 200 is configured to start transmitting this signal no later than a predetermined amount of time (tₛₜₐᵣₜ) 1 after entering a “Digital Ping” phase, and to continue transmitting this signal for a minimum predetermined period (t_{identification}) seconds. According to some modifications, tₛₜₐᵣₜ may be 15 ms. According to other modifications, t_{identification} may be 15 ms or 40 ms.

Further details regarding this embodiment can be found in section 3.2.2 of the test procedures.

According to some embodiments, the secondary unit 200 is configured to delay the opening of its output during “Digital Ping” and “Identification” phases, until it enters a “Power Transfer” stage. That is:

Vₒᵤₜ_{_{—}}_{NoEngag}=0 (5)

where Vₒᵤₜ_{_{—}}_{NoEngag} is voltage between the secondary inductive coil 210 and the electric load 220 during digital pings, under an alignment condition.

Further details regarding this embodiment can be found in section 3.2.3 of the test procedures.

According to some embodiments, the secondary unit 200 may be further configured to charge via a wired charger. In such a case, it may be configured such that the time elapsing from engagement with the wireless power outlet 100 until notification is up to 1 second longer than the time elapsing from an external wired charger connection until notification.

Further details regarding this embodiment can be found in section 3.2.4 of the test procedures.

According to some embodiments, the secondary unit 200 is configured, upon commencing an Identification phase, to transmit a predefined set of signals, including “PMA Dec”, “PMA Inc” (i.e., a request to increment power), and “PMA NoCh”, in order to stabilize in a certain operation point, after which it transmits an “RXID” signal. The secondary unit 200 is configured to transmit the set of signals (i.e., “PMA Dec”, “PMA Inc”, and “PMA NoCh”) within a period of time not to exceed 180 ms, both under alignment and misalignment conditions. In the event that the wireless power outlet 100 fails to validate the “RXID” signal, it shall revert to a standby mode, e.g., by removing a power signal.

Further details regarding this embodiment can be found in sections 3.3.1, 3.3.2, and 3.3.3 of the test procedures.

According to some embodiments, the secondary unit 200 is configured to operate at a single resonance peak, with an operating point which is at a frequency that is higher than the resonance peak frequency. This higher frequency (i.e., of the operating point) is associated with transfer of a lower amount of power.

Further details regarding this embodiment can be found in section 3.4.1 of the test procedures.

According to some embodiments, the secondary unit 200 is configured to tune its self-resonant frequency circuitry to be lower than a resonant frequency associated with the wireless power outlet 100 (e.g., of the primary inductive coil 110). It may be further configured to have a resonant frequency which is lower than a minimum frequency associated with the wireless power outlet 100 when placed thereon.

Further details regarding this embodiment can be found in section 3.4.2 of the test procedures.

According to some embodiments, the wireless power outlet 100 is configured to terminate power it receives an invalid signal from the secondary unit 200. According to some modifications, the wireless power outlet 100 is configured to terminate power if receipt of valid signals is interrupted for more than 3.4 ms. The wireless power outlet 100 may be further configured to terminate power if periods of interruption are not separated by receipt of at least four valid signals from the secondary unit.

Further details regarding this embodiment can be found in section 3.5.2 of the test procedures.

According to some embodiments, the secondary unit 200 is configured to send a request whenever it determines that the power level transmitted by the wireless power outlet 100 should be changed. In particular, it is configured to continue to send a “PMA Dec” signal whenever a decrease in power is required, and a “PMA Inc” signal whenever an increase in power is required. Thus, the secondary unit 200 is configured to refrain from sending either a “PMA Inc” or “PMA NoCh” when a decrease in power is required.

It is further configured to refrain from sending either a “PMA Dec” or “PMA NoCh” when an increase in power is required.

Further details regarding this embodiment can be found in section 3.5.3 of the test procedures.

According to some embodiments, the wireless power outlet 100 is configured to respond to a change request (i.e., a “PMA Dec” or “PMA Inc”) within a predetermined time window after it is issued by the secondary unit 200. The secondary unit 200 is configured to verify, for example by measuring frequency and/or voltage, that the requested change in operating point has been performed within the time window. In particular, the time window is between 50 μm and 150 μm.

Further details regarding this embodiment can be found in section 3.6.1 of the test procedures.

According to some embodiments, the secondary unit 200 is configured to ensure that it can complete a full charging cycle when on the surface 160, and the wireless power outlet 100 is active. It may vary charging periods or utilize non-contiguous charging periods, as long as it continues to indicate “charging in process” to a user. The secondary unit 200 is configured to remain in a charging state for a predefined maximal charging time, or for two hours, whichever is shorter.

Further details regarding this embodiment can be found in section 3.6.2 of the test procedures.

According to some embodiments, the secondary unit 200 is configured to operate within a predefined nominal (i.e., stated) voltage limit, and produce a predefined output ripple to the electric load 220. The secondary coil 220 is further configured such that the output voltage and output ripple to the electric load 220 remain within their predefined limits during increase or decrease of load for the entire range of loads supported thereby.

According to some examples, for example secondary units 200 which are designed for generic use not coupled to a specific electric load, the ripple level is limited to ±5% of the operating voltage thereof. According to some modifications of this example, the secondary unit 200 may produce a transient ripple, e.g., of 100 ms and/or up to ±20% of the operating voltage, when a load is switched.

Further details regarding this embodiment can be found in section 3.6.3 of the test procedures.

According to some embodiments, the wireless power system 10 is configured to limit power loss, under alignment and misalignment conditions. Accordingly, the wireless power system 10 is configured such that:
losses during wireless power transfer are no greater than 2 W; or
the system 10 operates at an efficiency of 60% for electric loads that are greater than one half of the maximum output current of the wireless power outlet 100, and at an efficiency of 50% for electric loads that are greater than one quarter of the maximum output current of the wireless power outlet and less than one half of the maximum output current of the wireless power outlet.

Further details regarding this embodiment can be found in section 3.6.4 of the test procedures.

According to some embodiments, the secondary unit 200 is configured for wired charging in addition to wireless charging. In such a case, the secondary unit 200 is configured such that the overall time required to fully charge the electric load 220 wirelessly is comparable to the time required to fully charge it via wired charging.

Further details regarding this embodiment can be found in section 3.6.5 of the test procedures.

According to some embodiments, the secondary unit 200 is configured such that, during standard operation, it does not emit audible sounds that exceed a sound pressure level (SPL) of 30 at a distance of 1 meter therefrom. The SPL may be measured by any suitable device known in the art, such as a sound level meter.

Further details regarding this embodiment can be found in section 3.6.6 of the test procedures.

According to some embodiments, the secondary unit 200 is configured to identify that charging of the electric load 220 is completed, to subsequently disable all out output of the secondary inductive coil 210 and transmit a “PMA EOC” (i.e., end of charge) signal to instruct the wireless power outlet 100 to terminate charging.

According to some examples, the secondary unit 200 is configured to identified that charging is completed when the output current of the wireless power outlet 100 is no greater than 5% of the maximum output current thereof. Further according to this embodiment, the wireless power outlet 100 is configured to terminate its output voltage, i.e., such that the output voltage thereof is 0, upon receipt of a “PMA EOC” signal, e.g., within a time period not to exceed a predetermined time period.

The secondary unit 200 is further configured to remain in a power transfer phase after transmitting the “PMA EOC” signal until the wireless power outlet 100 removes power (i.e., terminates its output voltage).

Further details regarding this embodiment can be found in sections 3.7.1 and 3.7.2 of the test procedures.

According to some embodiments, the secondary unit 200 is configured to identify conditions, e.g., error conditions, which trigger it to transmit a “PMA EOC” signal followed by the transition of the system to an End of Charge phase. These conditions may include states such as “No-Load” and “Error in Control Loop”.

A “No-Load” condition may include sudden removal or absence of load while being engaged with the wireless power outlet 100. This may apply to scenarios wherein the electrical load 200 is separated from the secondary coil 210, which is placed or remains on surface 160 without it. The secondary unit may comprise a detector (not illustrated) for this purpose. The secondary unit 200 may be further configured to identify that no load is connected thereto when an output current of the wireless power outlet 100 is below a minimal predefined threshold, and transmit a “PMA EOC” within a predetermined amount of time upon entering a Power Transfer phase.

An “Error in Control Loop” condition may include the secondary unit 200 being unable to stabilize the output voltage to its defined operational range for a time period exceeding 500 ms. It is configured to transmit a “PMA EOC” signal immediately in such a case. The secondary unit 200 may be further configured to terminate charging if it is unable to regulate the coil voltage to a vendor defined preferred operational range for a time period exceeding 500 ms.

Further details regarding this embodiment can be found in section 3.7.3 of the test procedures.

According to some embodiments, the secondary unit 200 is configured to stabilize delivered power for any possible operating point within a predefined frequency range. It is further configured to ensure that no oscillation (e.g., alternating requests of “PMA Dec” and “PMA Inc” signals) can occur, and that stabilization is always possible.

Further details regarding this embodiment can be found in section 3.7.4 of the test procedures.

According to some embodiments, the secondary unit 200 is configured to be ready to respond to a new ping (e.g., a digital ping) no later than a predetermined time period, e.g., 25 ms, after a power signal from the wireless power outlet 100 is removed. In such a case, the secondary unit 200 is configured to transmit an “RXID” signal immediately upon the termination of the predetermined time period and receipt of a digital ping from the wireless power outlet 100.

Further details regarding this embodiment can be found in section 3.7.5 of the test procedures.

According to some embodiments, the secondary unit 200 is configured to ensure that, during regular operation, it will not draw more than the maximal power that can be delivered by the wireless power outlet 100. According to some examples, the maximal power is 8.5 W.

Further details regarding this embodiment can be found in section 3.8.1 of the test procedures.

According to some embodiments, the secondary unit 200 is configured to protect the electric load 220 from damage and/or other safety issues. According to some examples, the secondary inductive coil 210 may be configured to disable its output or limits its current and/or voltage when a predefined threshold of voltage and/or current is exceeded for a period of time greater than 500 ms. The secondary unit 200 may comprise suitable protection circuitry (not illustrated) for this purpose.

Further details regarding this embodiment can be found in sections 3.8.2 and 3.8.3 of the test procedures.

According to some embodiments, the secondary unit 200 is configured to detect if the temperature at a surface engaged with the surface 160 of the wireless power outlet 100 reaches a predefined maximum temperature (e.g., 60° C.), and to immediately transmit a “PMA EOC” signal. For this purpose, the secondary unit may further comprise a temperature sensor (not illustrated), such as a thermistor or a thermocouple, in a suitable location to measure the temperature at the surface engaged with the surface 160 of the wireless power outlet 100.

Further details regarding this embodiment can be found in section 3.8.4 of the test procedures.

According to some embodiments, the secondary unit 200 may comprise (or be connected to for charging a device comprising) one or more radios. It is configured so as to not significantly reduce the sensitivity of any of the radios included in the device being charged, when the secondary unit 200 is actively engaged with the wireless power outlet 100, compared to when the secondary unit is not actively engaged with the wireless power outlet.

Further details regarding this embodiment can be found in section 3.9.1 of the test procedures.

Those skilled in the art to which this invention pertains will readily appreciate that numerous changes, variations and modifications can be made without departing from the scope of the invention mutatis mutandis.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the composition or method.

As used herein, the singular form “a”, “an” and “the” may include plural references unless the context clearly dictates otherwise. For example, the term “a compound” or “at least one compound” may include a plurality of compounds, including mixtures thereof.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals there between. It should be understood, therefore, that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the disclosure.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A wireless power outlet configured to provide an electric charge wirelessly to a secondary unit, the wireless power outlet comprising a primary inductive coil connected to a power source via a driver configured to provide an oscillating driving voltage to said primary inductive coil, the wireless power outlet being characterized by one or more selected from the group consisting of:
peak voltage across said primary inductive coil changes by at least 3V when a secondary inductive coil of said secondary unit is within a predetermined distance thereof;
a transition time between “Standby” and “Power Transfer” operational phases thereof does not exceed one second;
a response to a change request from said secondary unit is responded to by said wireless power outlet within 150 ms; and
receipt thereby of an invalid signal results in termination of power transfer.

2. A secondary unit configured to receive an electric charge wirelessly from a wireless power outlet, said unit comprising a secondary inductive coil wired to an electric load and being characterized by one or more selected from the group consisting of:
placement thereof on a surface of the wireless power outlet induces a difference of at least −40 Gauss in a DC magnetic field thereof;
an output of said secondary inductive coil remains closed until a signal, identifying itself as compliant with said wireless power outlet, is transmitted and a predetermined period of time elapses;
receipt of a digital ping from said wireless power outlet induces a response having a frequency of at least 7.6 kHz and no greater than 8.4 kHz;
an “Identification” operation phase thereof comprises transmitting, within 180 ms, signals indicating one or more of requesting increased power, requesting decreased power, and requesting no change in power until a stabilized operational point is reached, followed by a signal identifying itself as compliant with said wireless power outlet;
a request is transmitted by said secondary unit when it determines that a power level transmitted by said wireless power outlet should be changed;
a charging state is maintained until the earlier of said electric load reaches full power and said charging state has been maintained for two hours;
no audible sounds are emitted by said secondary unit during normal operation thereof which exceed a sound pressure level of 30 at a distance of one meter;
when charging of said electric load is complete, said secondary unit closes an output of the secondary inductive coil thereof and transmits a signal indicating end of charge;
a signal indicating end of charge is transmitted by said secondary unit when a predetermined error condition is detected;
the secondary unit is configured to transmit a signal identifying itself as compliant with said wireless power outlet upon receiving a digital ping therefrom 25 ms after transfer thereto of electric power terminates; and
no more than 8.5 W are drawn by said secondary unit from the wireless power outlet.
